(19) United States
(12) Patent Application Publication
(10) Pub. No.: US 2006/0271810 A1
(43) Pub. Date: Nov. 30, 2006

(54) Backup control system and method

(75) Inventors: Chao-Hsien Hsu, San Jose, CA (US); Chunyi Liao, Palo Alto, CA (US); Dean-Chung Wang, Milpitas, CA (US); Chun-Liang Lee, Taipei (TW); Ji-Chi Yang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION & 3UP Systems, Inc.

(21) Appl. No.: 11/209,810

(22) Filed: Aug. 24, 2005

(30) Foreign Application Priority Data
Sep. 3, 2004 (TW) 93126800

(51) Int. Cl. G06F 11/00

(52) U.S. Cl. 714/4

(57) ABSTRACT

A backup control system and method includes at least two system control modules and a power supply unit. The system control modules automatically detect the operating conditions of one another according to a determined logic of a backup control method. In the event that one system control module malfunctions, the operating condition is automatically transformed to continuing execute the control process and to enable that the power supply unit provides dynamically electric power according to loadings of the backup control system. Further, each system control module can automatically and immediately replace the other system control module to execute control processes and maintain the electronic equipment working, thereby reducing waste of electric resources.

### BACKGROUND

1. Field of Invention

The invention relates to a backup system and method, and more particularly to a backup system and method for blade servers to automatically execute backup procedures and dynamically supply power according to system conditions.

2. Related Art

The arrival of the E-era has created a great deal of business opportunities, but also has generated many problems. To provide non-stop service is a very important factor. Business opportunities are no longer bound by conventional time concepts. To offer full time service is a trend becoming increasingly popular in many businesses.

With enterprises growing continuously, appropriate compensation for damage or loss of important computer data is more difficult to obtain than for damage of physical property. Hence enterprises have to quickly control data and store the data safely to fully exploit business opportunities. At present, there are many non-stop backup solutions, such as cluster servers, off-site backup, dual-host systems, backup control systems and the like. Except for the backup control system, all other service and system schemes are quite expensive to set up.

Referring to FIG. 1, the architecture of a first embodiment of a conventional backup control system is shown. It includes a system control module 10, a back plane 15, electronic equipment 20, a power supply unit 25 and a display device 30.

The system control module 10 is connected to the electronic equipment 20, the power supply unit 25 and the display device 30 through the back plane 15 for controlling operations of a plurality of main boards (not shown in the drawing) in the electronic equipment 20.

In the event that the system control module 10 breaks down, the display device 30 shows error messages. All operations of the electronic equipment 20 is terminated until operators confirm the cause of breakdown through the display device 30 and manually repair. However, the enterprises will miss much business opportunities and lose important information during this interruption.

To solve the aforesaid problems, a backup control system using two system control modules has been introduced. FIG. 2 illustrates the architecture of a second embodiment of a conventional backup control system. It includes a main system control module 35, a backup system control module 40, a power supply unit 45, a back plane 50, and electronic equipment 55.

The main system control module 35 and the backup system control module 40 are connected to the electronic equipment 55 and the power supply unit 45 through the back plane 15 for controlling operations of a plurality of main boards (not shown in the drawing) in the electronic equipment 55.

In the event that the main system control module 35 breaks down, the backup system control module 40 is to substitute the main system control module 35 by artificial or automatic way to control the electronic equipment 55. In this case, sometimes it is inconvenient that the main system control module 35 and the backup system control module 40 are usually installed at fixed locations and the backup control system just work in the situation that the main system control module 35 was first installed.

Moreover, the power supply unit 45 includes a first power supply device and a second power supply device, each having to provide electric power to the backup system having maximum loadings, thereby provide mutual backup in case one of them malfunctions. In such case, it wastes resources and has cooling problems.

Furthermore, the power supply to provide electric power to greater loadings has the larger power and it is quite expensive to set up the power supply. As the main boards in the electronic equipment 55 may be removed and replaced, the backup control system might not have to support the maximum loadings. Hence to design the power supply with larger power is not necessary. Moreover, the power supply with larger power generates more heat, so that heat dissipation of the electronic equipment is an important issue remaining to be resolved.

In addition, the main system control module 35, the backup system control module 40 and the power supply unit 45 are connected through the back plane 15. The wiring design of the back plane 15 is complicated, so that the signal interference may occur.

As the above, the loss caused by malfunction of the backup control system is difficult to quantify. However, it is a goal pursued in the industry to design a backup control system that can automatically execute backup procedures, prevent energy loss occurring to the power supply unit, and prevent unnecessary heat generation.

### SUMMARY

An object of the invention is to resolve the aforesaid problems. The invention provides a backup control system and method with two or more system control modules that can automatically switch operation modes and a power supply unit that can adjust power supply conditions according to the load of the backup control system, so that the backup control system can maintain normally working and alleviate heat generation problems.

In order to achieve the foregoing object, the backup control system according to the invention includes at least two system control modules and a power supply unit. Each system control module has a backup arbitrated unit and a baseboard management controller. The backup arbitrated unit sets operating situation of every system control module. The baseboard management controller transmits control signals of the system control module, which operates in an active mode, to control operation of each main board in the electronic equipment. The power supply unit can switch power supply conditions by the system control module thereby provide electric power required by the backup control system.

In addition, the invention also provides a backup control method that has determination logic to enable two system control modules to automatically switch operation modes. The method includes the following steps: generating a system ready signal after an electronic equipment has turned on, and confirming whether another system control module has generated an active signal; setting the operating condition for an active mode when another system control module does not generate the main control signal, and continuously generating the active signal. By contrast, when another system control module generates the active signal, the operating condition is set in a ready mode and a backup signal is generated.

### BRIEF DESCRIPTION OF THE DRAWINGS

The invention will become more fully understood from the detailed description given herein below illustration only, and thus are not limitative of the present invention, and wherein:

FIG. 1 is a schematic block diagram showing a configuration of a first embodiment of a conventional backup control system;

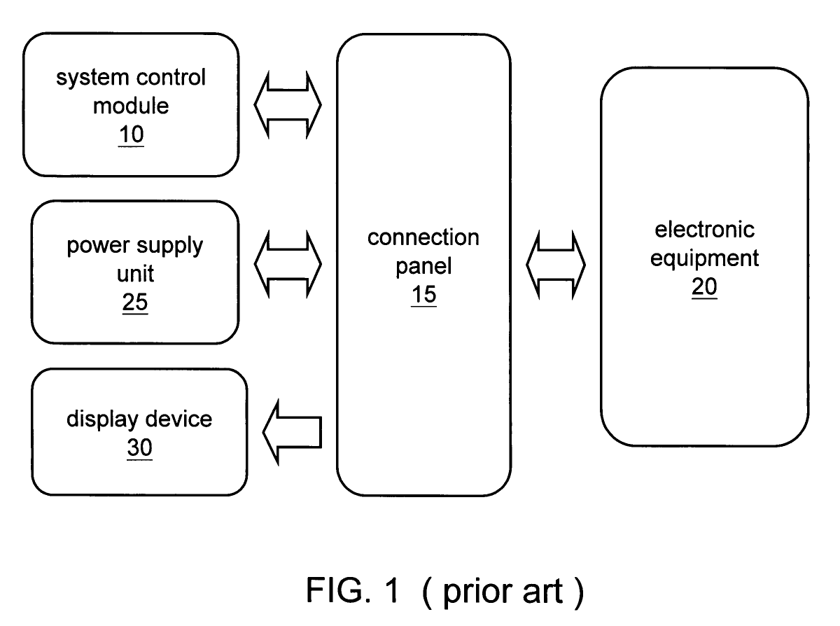

FIG. 2 is a schematic block diagram showing a configuration of a second embodiment of the conventional backup control system;

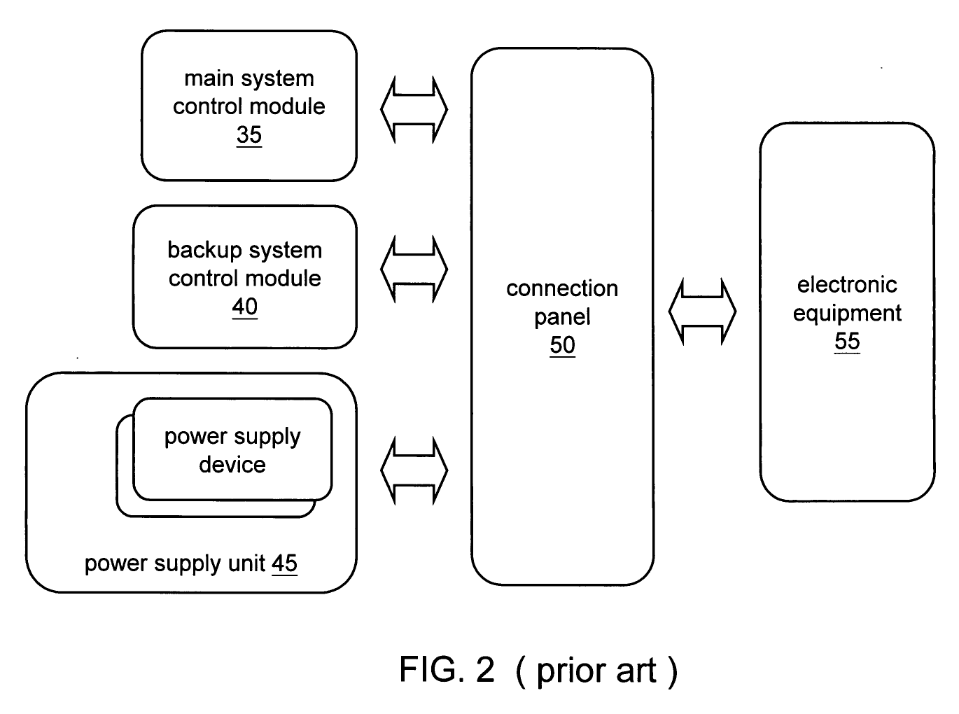

FIG. 3 is a schematic block diagram showing a configuration of a backup control system according to an embodiment of the present invention; and

FIG. 4 is a schematic block diagram showing a process flow of a backup control method according to an embodiment of the present invention.

### DETAILED DESCRIPTION OF THE INVENTION

Reference will now be made in detail to the preferred embodiments of the present invention, examples of which are illustrated in the accompanying drawings.

The backup control system according to the invention can be adopted in the management controller of electronic equipment (such as a blade server) thereby control operating conditions of a plurality of main boards in electronic equipment.

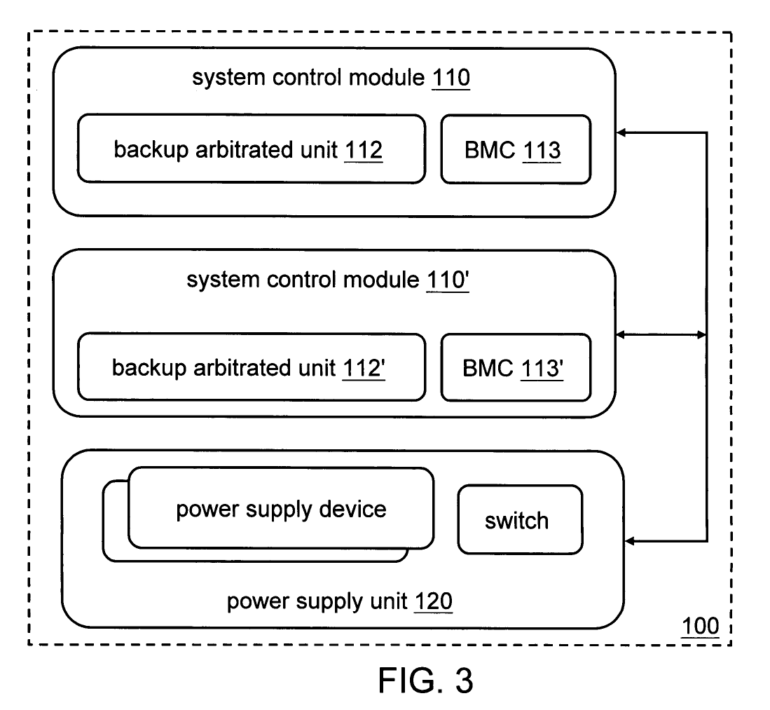

Referring to FIG. 3, the backup control system 100 includes: (A) at least two system control modules 110 and 110′, and (B) a power supply unit 120. Details are described as follows:

(A) Each of the system control modules 110 and 110′ has a backup arbitrated unit 112 or 112′ and a baseboard management controller (BMC) 113 or 113′. The backup arbitrated units 112 and 112′ set operating conditions of the system control modules 110 and 110′. The BMC 113 and 113′ transmit control signals generated by the system control modules 110 and 110′ to the electronic equipment (not shown in the drawing) for controlling operating condition of every main board in the electronic equipment and receiving condition signals generated by every main board.

Any one of the system control modules 110 and 110′ can execute control processes by itself for the main boards in the electronic equipment. Determining which of the system control modules 110 and 110′ execute control processes depends on setting the operating condition of the system control modules 110 and 110′ to an active mode or a ready mode.

Setting the operating condition is determined by the coupling sequence of the system control modules 110 and 110′ to the electronic equipment, or determined by an internal algorithm automatically set in the active mode or ready mode. The system control modules 110 and 110′ in the active mode can execute the control process to control the operating condition of each main board in the electronic equipment.

For instance, while the system control module 110 set in the active mode is out of order, the backup control system 100 executes an operating condition switch procedure to automatically switch the system control module 110′, which is originally set in the ready mode, to the active mode, and the malfunctioning system control module 110 is automatically reset and its operating condition is switched to the ready mode. As a result, the system control module 110′ switched to the active mode replaces the original active mode system control module 110 to execute the control process thereby maintain the electronic equipment in normal operation.

(B) The power supply unit 120 includes two and upward power supply devices and a switch. Each power supply device is connected to the system control modules 110 and 110′ via the switch, and switches power supply conditions according to the status of the system control modules 110 and 110′.

The system control module 110 or 110′ being in the active mode generates a corresponding control signal according to the amount of loadings in the backup control system 100, and transmits the control signal to the switch for dynamically controlling the operation of each power supply device. Therefore, each power supply device generates the required power.

In this case, the power supply unit 120 supplies the electric power no less than what is needed to support the maximum loadings in the backup control system 100. The power supply devices may also be formed like main boards and installed in the electronic equipment, or be set up independently in the backup control system 100.

There is not special restriction on the interconnection between the backup arbitrated units 112 and 112′, the system control modules 110 and 110′ and the main boards in the electronic equipment, as long as the backup arbitrated units 112 and 112′ can detect whether the operating condition of one another is normal, and the BMCs 113 and 113′ of the system control modules 110 and 110′ can receive condition signals sent by the main boards, or transmit the control signal to the main boards to execute control processes.

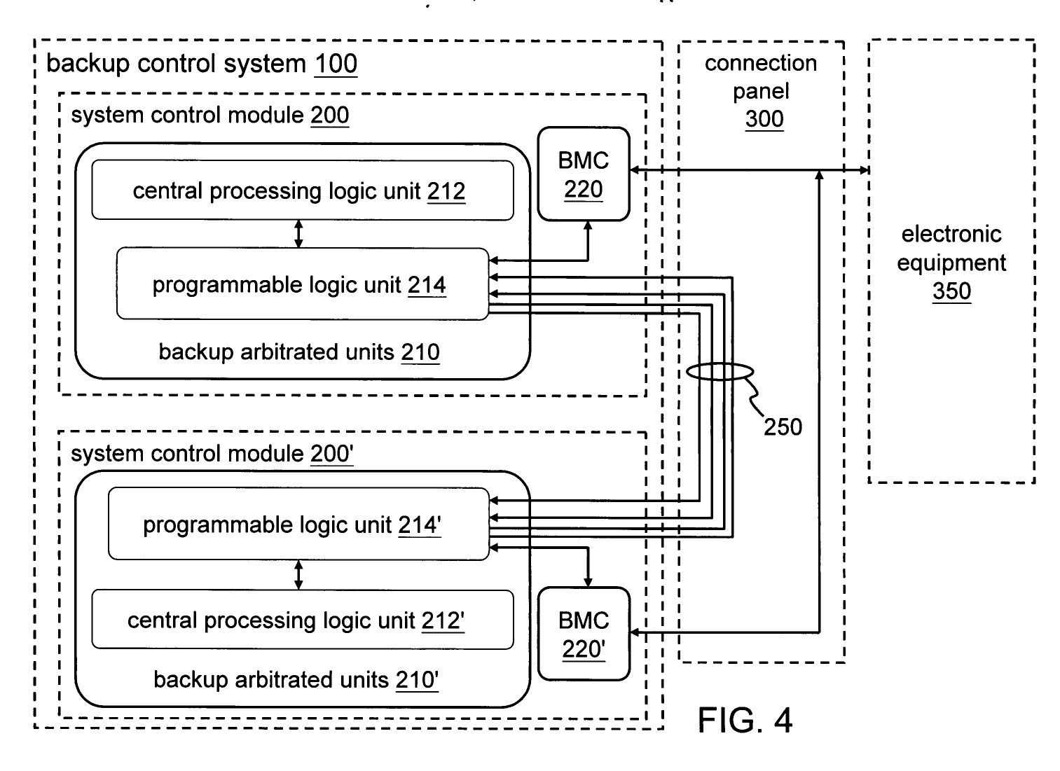

More details of the signal receiving and transmitting method of the backup control system 100 are elaborated below through an embodiment shown in FIG. 4. It includes backup arbitrated units 210 and 210′ coupling through a back plane 300, and baseboard management controllers (BMCs) 220 and 220′ connecting to every main board (not shown in the drawing) in the electronic equipment 350 through the back plane 300.

Each system control module 200 or 200′ has a backup arbitrated unit 210 or 210′, and a BMC 220 or 220′. Each backup arbitrated unit 210 or 210′ has a central processing logic unit 212 or 212′, and a programmable logic unit 214 or 214′.

The central processing logic units 212 and 212′ are connected respectively to the programmable logic units 214 and 214′. The programmable logic units 214 and 214′ are connected to one another and the BMCs 220 and 220′ through a plurality of signal lines 250 and the back plane 300. The BMCs 220 and 220′ are further connected to every main board of the electronic equipment 350 through the back plane 300. The signal lines 250 transmit condition signals (active signal or ready signal) to enable the system control modules 200 and 200′ to detect whether one another's operating condition is normal.

When the system control module 200 or 200′ operates in the active mode, it sends an active signal via the signal line 250 of the programmable logic 214 or 214′ to the connecting BMC 220 or 220′ and another system control module 200′ or 200. By contrast, when the operating condition is in the ready mode, a ready signal is sent to the BMC 220 or 220′ and another system control module 200 or 200′.

The method for setting the operating condition of the system control module 200 according to the connection condition is elaborated below. When the power is on and initialization is finished, the central processing logic 212 sends a system ready signal to the programmable logic unit 214. After the central processing logic 212 receives the system ready signal, it 212 confirms through the signal line 250 that another programmable logic unit 214′ does not send the active signal. Therefore it sets the system control module 200 to the active mode and continuously sends an active signal through the signal line 250.

By contrast, when it is confirmed that another programmable logic unit 214′ has sent an active signal, it automatically sets itself to the ready mode and continuously sends a ready signal. When the programmable logic units 214 and 214′ send the active signal at the same time, the backup control system 100 automatically sets active mode for one of them.

In the event that the system control module 200 malfunctions and the corresponding programmable logic unit 214 cannot send the active signal through the signal line 250, another programmable logic unit 214′ automatically executes the switch procedure according to the operating condition and changes to the active mode, while sending active signal stops.

As previously discussed, when the BMC 220 or 220′ confirms that the transmitting condition signal of the connecting programmable logic unit 214 or 214′ is the active signal, it executes the control process for each main board of the electronic equipment 250 through the back plane 300.

In practical applications, the electronic equipment may be servers, blade servers, power supplies (such as power supply devices and non-stop power systems), cooling devices, data storage devices, and the like. The programmable logic unit may be a complex programmable logic device (CPLD) or an application specific integrated circuit (ASIC).

In summary, the invention automatically sets the control module to an active mode or a ready mode according to an installation sequence or an internal algorithm thereby executes a control procedure and achieves automatic backup. Each power supply device is connected to the system control module via a single switch. Hence the design problems of having too much wiring on the back plane (such as signal interference or space constraints) may be alleviated, and the power supply unit can dynamically supply electric power to alleviate heat generation problems.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A backup control system, suitable for an electronic equipment having a plurality of main boards to control operating of the main boards, the backup control system comprising:
two or more system control modules, each comprising:
a backup arbitrated unit for setting an operating condition of each the system control module to one of an active mode and a ready mode, wherein only one of the system control modules is set in the active mode; and
a baseboard management controller for transmitting at least one control signal in response to the system control module, the operating condition of which is in the active mode to the main boards, thereby controls operations of the main boards;
wherein when the system control module in the active mode malfunctions, the operating condition of the system control module in the ready mode is switched in the active mode, thereby continuously controlling the operations of the main boards; and
a power supply unit having at least two power supply devices, which switch power supply condition according to the control signal from the system control module to provide electric power for the backup control system to work.

2. The backup control system of claim 1, wherein the system control modules, the power supply unit and the main boards are interconnected by a back plane to transmit signals.

3. The backup control system of claim 1, wherein the baseboard management controller is used to receive condition signals of the main boards.

4. The backup control system of claim 1, wherein the system control module sets the operating condition of each of the system control modules in one of an active mode and a ready mode according to one of an internal algorithm and a connecting sequence of the system control module to the electronic equipment.

5. The backup control system of claim 1, wherein each of the power supply devices switches the power supply condition thereof by a switch.

6. A backup control method for setting an operating condition of one of two system control modules according to a system ready signal generated after having finished a power on procedure, comprising the steps of:
confirming an condition that one of the system control modules generates an active signal according to the system ready signal by another of the system control modules; and
setting the operating condition of the another of the system control modules in an active mode and generating the active signal when the one of the system control modules does not generate the active signal.

7. The backup control method of claim 6, wherein the another of the system control modules is set the operating condition in a ready mode when the one of the system control modules generates the active signal.

8. The backup control method of claim 7, wherein when the another of the system control modules, which is set the operating condition in the ready mode, continuously confirms the condition that the one of the system control modules generates an active signal, and when the active signal is not generated by the one of the system control modules, the operating condition of the another of the system control modules is switched to the active mode and the another of the system control modules generates the active signal.
